(19) United States
(12) Patent Application Publication
(10) Pub. No.: US 2003/0085571 A1
(43) Pub. Date: May 8, 2003

(54) Waste removal conduit attachment for use with mobile sewage units

(76) Inventor: Richard D. Avery, San Jose, CA (US)

Correspondence Address: DAVID A. BOONE, ATTORNEY AT LAW, P.O. BOX 2125, SARATOGA, CA, 95070, US

(21) Appl. No.: 10/035,385

(22) Filed: Nov. 8, 2001

(51) Int. Cl. F16L 33/18; F16L 17/00

(52) U.S. Cl. 285/361; 285/396

(57) ABSTRACT

A device to reduce s and leakage from the sewage removal systems typical of recreational vehicles includes an annular coupler to provide a water-tight seal while enabling free, full rotational movement of the waste removal hose at the point of its connection to the external waste outlet for positioning until locked into the desired position, thus permitting a connection to a waste receiving tank from any direction. The use of an angled or curved pipe further increases the ability to position the device in a manner that provides the least stress at the point of the attachment of a waste-removal hose. The device is an attachment which fits between a standard external waste outlet and a standard flexible waste-removal hose. A method of making a waste-removal conduit attachment from commercially available parts is also provided.

### REFERENCES CITED

U.S. Pat. No. 4,650,224 Mar. 17, 1987 D. Smith

U.S. Pat. No. 4,796,926 Jan. 10, 1989 B. Rapsilver

U.S. Pat. No. 5,247,974 Sep. 28, 1993 C. Sargent et al.

U.S. Pat. No. 4,854,349 Aug. 8, 1989 D. Foreman

U.S. Pat. No. 4,133,347 Jan. 9, 1979 A. Mercer

U.S. Pat. No. 5,971,438 Oct. 26, 1999 A. Johnson

U.S. Pat. No. Des. 324,727 Mar. 17, 1992 C. Rowley

No federally sponsored research or development was used in this invention.

### BACKGROUND OF THE INVENTION

Self contained sewage disposal systems found in recreational vehicles (known as “RV”s) and the like use standard means and methods for the removal of sewage from the on-board holding tank to a sewage containment receptacle at a rest facility, recreational vehicle park or similar site. Typically, the self-contained systems utilize an externally accessible stub-pipe sewage outlet to which a sewage removal hose can be connected to empty the contents of the onboard holding tank. The waste discharging end of the sewage removal hose is extended from the vehicle to a sewage containment receptacle into which the contents of the holding tank are emptied.

Depending on the physical arrangement of the vehicle and the sewage containment facilities, the sewage removal hose may be unduly stretched, twisted or kinked. This can cause the hose to be ill-fitted to the RV with the consequence of leaks, tears, or other damage and blockage of the free passage of the stream of sewage. As a result, unsanitary, unhealthy, and obnoxious spills of sewage can occur and frequent replacement of the hose is necessary.

There is therefor a need to reduce excess stress, wear and tear on the sewage removal hose and a need to avoid unduly kinking or twisting the hose. Some efforts to remedy this situation use rigid telescoping tubing in place of flexible hoses as is evidenced by U.S. Pat. No. 4,650,224. Others concentrate on the integrity of the seal between the sewage removal hose and the intake opening of the containment receptacle, as in U.S. Pat. No. 4,796,926 and U.S. Pat. No. 5,247,974 which is a pneumatic device. Still others entirely replace the external hose and system that is standard equipment with most RVs with alternative conduit systems, some of which are self contained, see U.S. Pat. Nos., 4,854,349, 4,133,347 and 5,971,438, which uses threaded elbow joints to attach to the waste outlet and site inlet. A design patent for a motorhome bayonet ground waste connection, D324, 727, is an angled, handled pipe showing no means of attachment to the stub-pipe waste outlet.

This invention augments rather than replaces the external sewage disposal system, making use of all of the items that come as standard waste removal equipment with most RVs, providing a simple, inexpensive mechanical means for obtaining a reliable fit to the external stub-pipe while lessening the stress and extreme twisting of the hose. It is expected that this attachment would most often be manually connected to the external waste outlet and not require the use of any additional power or tools. It provides a secure seal at the externally accessible outlet, thus preventing leakage and strain at that point. The result is a longer useful life for the sewage removal hose, less likelihood of leakage from the stub pipe or hose, and less damage to the hose or the RV waste outlet stub-pipe while in use.

### SUMMARY OF THE INVENTION

The present invention is a rotationally adjustable sealing waste-hose conduit attachment which connects at one end to an external sewage outlet stub-pipe, such as those typically found on recreational vehicles, and attaches at its opposite end to the flexible sewage removal hose normally provided as standard equipment for use with mobile sewage units. In the preferred embodiment, the waste-hose conduit attachment includes a curved or angled pipe or pipe segment which attaches at its waste discharging end to the flexible hose.

By fitting between the outlet stub-pipe and the flexible sewage removal hose, the attachment prevents the hose from being unnecessarily strained, damaged, or kinked while in use. The standard stub-pipe is a round, rigid, outlet tube with regularly spaced pegs protruding perpendicularly from the outer circumference of the tube, which pegs act as knobs upon which an annular coupler may attach.

The attachment comprises a rigid, frictionally engaging, self-sealing, rotationally adjustable annular coupler can be directly or indirectly connected to a flexible waste-hose. Alternatively, the conduit attachment may be extended in length by a pipe or similar means, including by means of a cylindrical elbow tube which terminates with a waste-hose connection at the waste discharging end. In all embodiments, the conduit attaches to the outlet stub-pipe by use of an annular coupler which uses a frictionally engaging means to secure the coupler to the pegs of the stub-pipe in a locking manner, providing a firm, water-tight seal yet permitting free and full rotation of the waste removal hose within the opening of coupler.

The annular coupler is swivel mounted upon the waste receiving end of a waste removal hose or at the waste receiving end of an extension connected to the waste removal hose. In the preferred embodiment, the annular coupler is swivel mounted upon an angled extension attached to the waste receiving end of a waste removal hose. Until the coupler has been locked into place, the remainder of the length of the conduit plus any hose or other extension attached to the conduit can move freely in a 360° fully rotational manner thus permitting repositioning abilities that are suitable for whatever external waste disposal arrangement is encountered.

The invention further provides a method of constructing a waste-hose conduit attachment by using off the shelf plumbing parts and supplies.

### DETAILED DESCRIPTION OF THE DRAWINGS

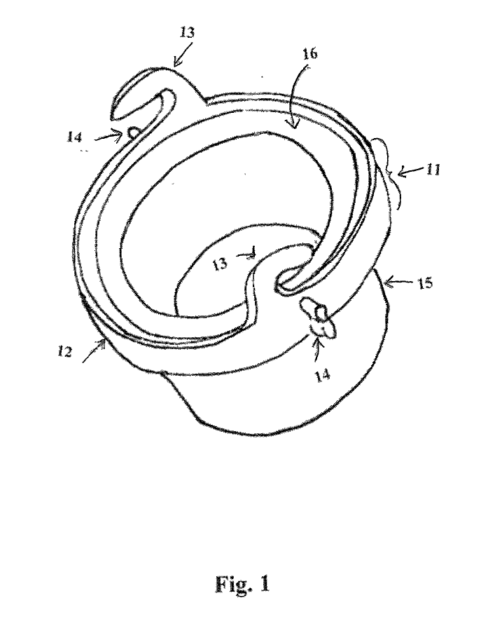

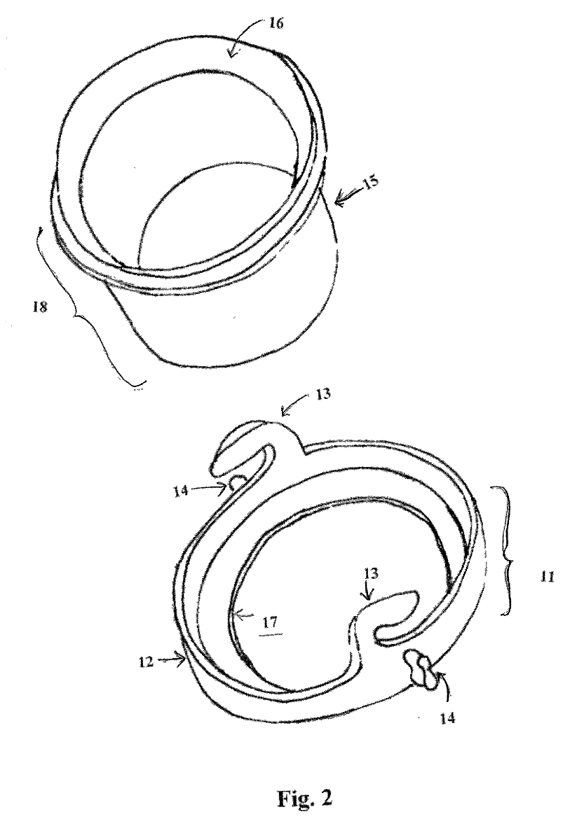

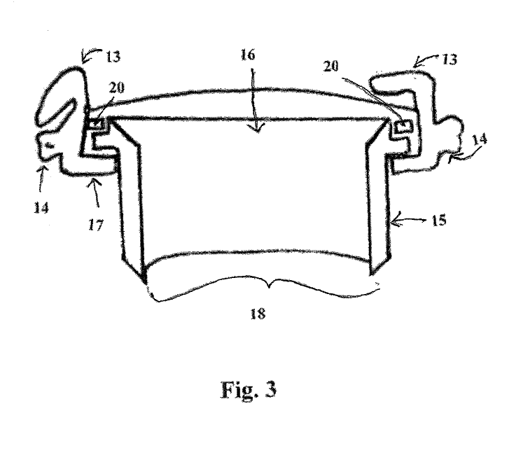

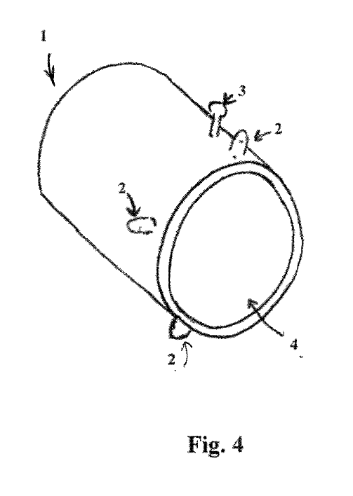

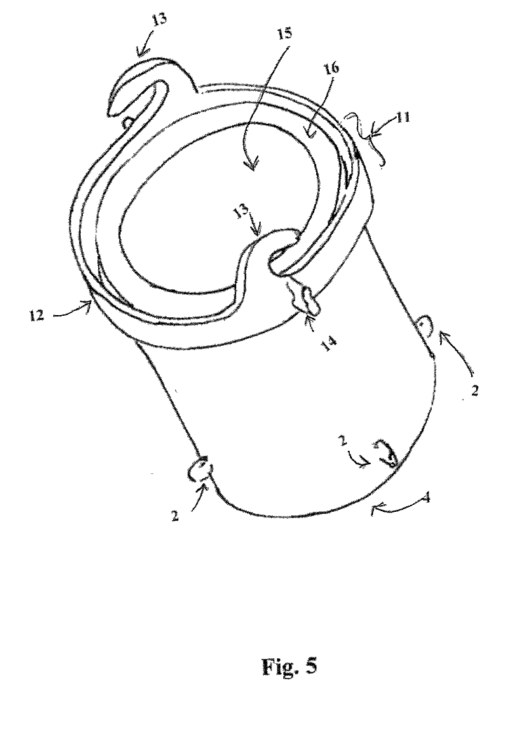

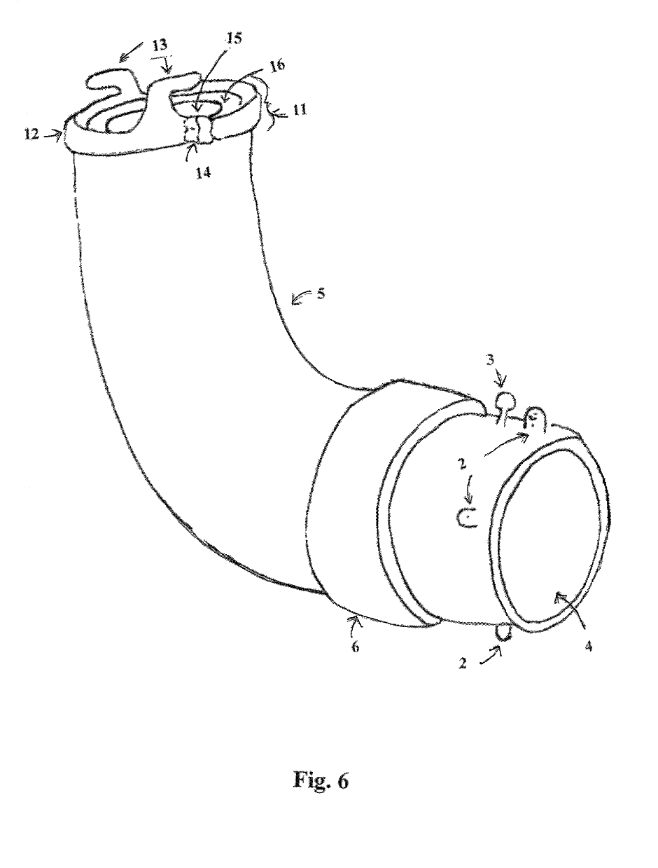

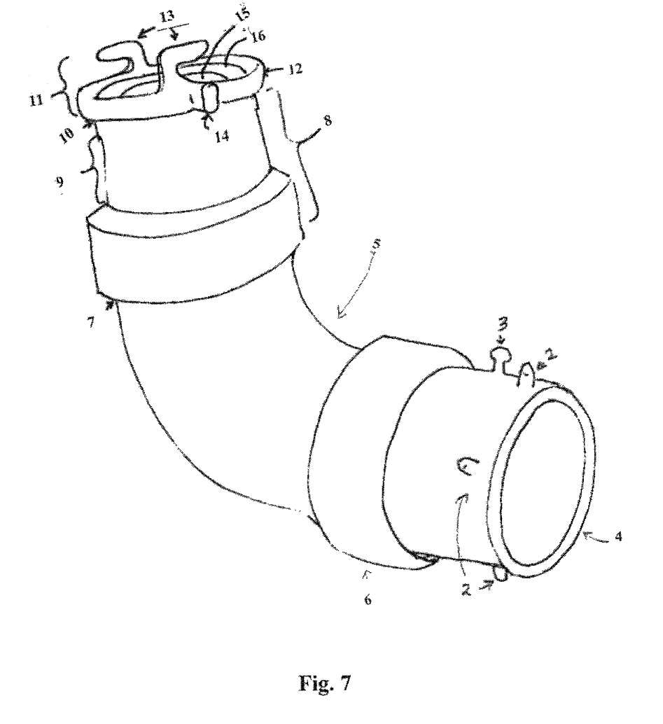

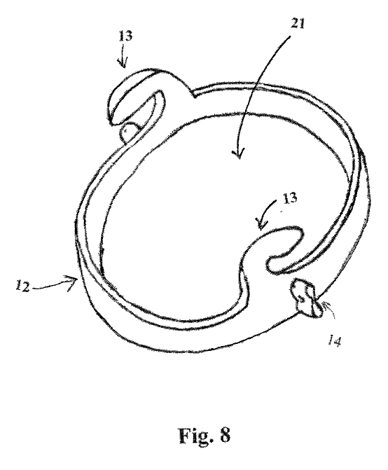

The drawings show (FIG. 1) an annular coupler positioned about a short pipe means; (FIG. 2) the separated components of FIG. 1; (FIG. 3) a cross section view of FIG. 1; (FIG. 4) a stub-pipe waste outlet; (FIG. 5) an embodiment featuring a stub-pipe as a means of attaching a flexible waste removal hose; (FIG. 6) an embodiment showing a complete conduit attachment with a curved pipe-means and attachment means for a waste removal hose; (FIG. 7) the preferred embodiment which is also a product of the method claim for the conduit attachment; and (FIG. 8) a termination cap prior to its modification for use in the method claim.

FIG. 1 shows the conduit attachment in a preliminary embodiment, comprising a pipe-means conduit with a straight body (15) and one flanged end (16) and an annular coupler (11) said coupler having a base (not visible in this figure), a rim rising perpendicular from the base (12) with hook means (13) for attachment to a stub-pipe waste outlet projecting upward from the rim (12) and a stud-like knob projecting laterally from the rim for manipulation of the coupler (14). The body of the conduit fits within the opening of the annular coupler while the flanged end of the conduit is wider than the internal diameter of the annular coupler, thus preventing the conduit from fully passing through the coupler. This figure shows a conduit pipe means with a very short, straight body and without an attachment means for a flexible waste-removal hose.

FIG. 2 shows a short, straight bodied, flange ended conduit pipe-means (16) and annular coupler (11) as separate components. The figure shows the flanged end (16) of a conduit which flares out ward from the conduit body (15) there being in this instance a ridge (22) between the body of the conduit and the flange end which ridge projects beyond the outer diameter of the flange and upon which a malleable gasket (20) (not shown) can rest. The figure further shows the annular coupler before it is placed into position on the conduit, with the rim of the coupler (12) projecting upward from its base (17), a stud-like lateral projection (14) from the rim for manipulation of the coupler, and hooked engaging-members (13) projecting upward from the rim.

FIG. 3 shows a cutaway view of a short, straight, flanged conduit pipe-means (18) fitted with a malleable gasket (20) and an annular coupler situated at the flanged end (16) of the conduit pipe-means, the base (17) of said annular coupler in contact with the flange. Side views of hook shaped engaging members (13) and laterally projecting studs (14) are also shown.

FIG. 4 shows a cylindrical stub-pipe external waste outlet as it would protrude from the waste holding tank of a recreational vehicle. The stub-pipe has a waste receiving end (1) and a waste discharging end (4). Perpendicularly protruding from the stub-pipe proximate to the waste discharging end are pegs or knobs (2) upon which the hooks of an annular coupler can be firmly fastened. An additional perpendicularly protruding accessory peg (3) is present.

FIG. 5 shows an embodiment wherein a stub-pipe having pegs (2) upon which a waste hose may be connected has been fixedly attached to the body (15) of a flanged conduit pipe-means. An annular coupler encircles the conduit pipe-means below its flanged end and above the point at which the body of the pipe-means is attached to the stub-pipe.

FIG. 6 shows an embodiment having a stub-pipe at the waste-discharging end (4) as an attachment means for a flexible waste-removal hose, the stub-pipe being connected to a curved, elbow pipe-means (5) by use of a connecting collar (6), an annular coupler (11) located at the end of the elbow pipe-means opposite the stub-pipe, said annular coupler being held in a freely rotational position by the flanged end (15) of a conduit pipe-means, the body of which (16) has been fixedly attached to the internal surface of the elbow pipe. The annular coupler (11) has a low, upright rim (12) which projects upward from the base in a direction parallel to the elbow pipe-means. Projecting upward from the rim (12) of the annular coupler are hooks (13) which are capable of engaging knobs (2) protruding from a stub-pipe waste outlet. Jutting outward from the annular coupler (11), perpendicular to the direction of the elbow pipe-means (5) is at least one knob or stud-like projection (14) which acts as a grip and provides resistance for the purpose of gripping and manipulating the annular coupler (11) during its attachment to a stub-pipe (1). Sufficient space is available for the insertion of a malleable gasket (not shown) between the flanged end of the conduit pipe-means and a waste outlet.

FIG. 7 shows the preferred embodiment which is also a product of the method claim comprising a cylindrical elbow pipe (5) with a collared female (6) waste discharging end and a non-collared waste receiving end (7). A female adaptor (8) is permanently bonded at its female end to the non-collared, waste receiving end (7) of the cylindrical elbow pipe (5). The female adaptor (8) has a neck (9) which terminates in a waste receiving end (10) upon which is seated a swivel mounted annular coupler (11). The annular coupler (11) has a base (17) (not visible in FIG. 7) which loosely contacts the waste receiving end (10) of the female adaptor (8), upon which it rests. The annular coupler (11) has a low, upright rim (12) which projects upward from the base in a direction parallel to the neck (9) of the female adaptor. Projecting upward from the rim (12) of the annular coupler are hooks (13) which are capable of engaging knobs protruding from a stub-pipe waste outlet. Jutting outward from the annular coupler (11), perpendicular to the direction of the neck (9) of the female adaptor (8), is at least one knob or stud-like projection (14) which acts as a grip and provides resistance for the purpose of gripping and manipulating the annular coupler (11) during its attachment to a stub-pipe waste outlet (the outlet is not shown). The annular coupler (11) is permanently affixed to the neck (9) of the female adaptor (8) by means of a short, rigid, flanged conduit which is flanged at the waste receiving end (16) with a smooth body (15) that terminates at its waste discharging end (not visible). The body of the flanged conduit (15) fits snugly into the neck (9) of the female adaptor (8) to which it is permanently bonded. The flanged end (16) of the conduit (18) has an external diameter greater than the internal diameter of the base of the annular coupler (11), which the flanged end of the conduit holds permanently in place upon the female adaptor (8) when put in the locking position after the rotational movement of the annular coupler (11) to the desired position has been accomplished.

FIG. 8 shows a termination cap prior to its modification for use in the method claim, having a solid surface as its circular base (21), a rim (12) rising perpendicular to the base, stud-like projections(s) (14) extend laterally from the rim and evenly space hooked engaging means (13) project upward from the rim.

What is claimed is:

1. A waste removal conduit attachment for use with mobile sewage units having an external stub-pipe waste outlet and a flexible waste removal hose, said attachment comprising:
(a) a pipe means for receiving waste from said stub-pipe waste outlet; and,
(b) an annular coupler means encircling said pipe means, having at least two engaging means for engaging the pegs of a stub-pipe from any position to which the angular coupler may be rotated with respect to the stub-pipe waste outlet.

2. A waste removal conduit attachment for use with mobile sewage units having an external stub-pipe waste outlet and a flexible waste removal hose, as in claim 1, wherein the engaging means engages the pegs of the stub-pipe in an increasingly tight friction fit causing the pipe means and the stub pipe outlet to form a water-tight seal between them.

3. A waste removal conduit attachment for use with mobile sewage units having an external stub-pipe waste outlet and a flexible waste removal hose, as in claim 2, wherein the engaging means has a locking position with regard to the pegs of the stub-pipe outlet after the friction fit has reached sufficient tightness to form a water tight seal between the pipe means and the stub-pipe waste outlet.

4. A waste removal conduit attachment for use with mobile sewage units having an external stub-pipe waste outlet and a flexible waste removal hose, as in claim 3, wherein the waste receiving end of the pipe means has or is modified to have a lip, flange, rim or other projection of material which creates an external diameter wider than that of the internal diameter of the central opening of the annular coupler, providing a means by which the annular coupler can exert sufficient pressure against the stub-pipe to maintain a durable water-tight seal.

5. A waste removal conduit attachment for use with mobile sewage units having an external stub-pipe waste outlet and a flexible waste removal hose, as in claim 4, wherein a gasket means is used between the pipe means and stub-pipe outlet to provide a reliable seal.

6. A waste removal conduit attachment for use with mobile sewage units having an external stub-pipe waste outlet and a flexible waste removal hose, as in claim 5, wherein the pipe means is angled or curved in shape.

7. A waste removal conduit attachment for use with mobile sewage units having an external stub-pipe waste outlet and a flexible waste removal hose, as in claim 5, wherein the pipe means includes additional extensions or adaptor pipes.

8. A waste removal conduit attachment for use with mobile sewage units having an external stub-pipe waste outlet and a flexible waste removal hose, as in claim 7, wherein one or more of the additional extension or adaptor pipes are angled or curved in shape.

9. A waste removal conduit attachment for use with mobile sewage units having an external stub-pipe waste outlet and a flexible waste removal hose, as in claim 5, wherein there is a means for the attachment of a waste removal hose at the waste discharging end of the pipe means.

10. A waste removal conduit attachment for use with mobile sewage units having an external stub-pipe waste outlet and a flexible waste removal hose, as in claim 9, wherein the attachment means for the waste removal hose is a stub pipe.

11. A waste removal conduit attachment for use with mobile sewage units having an external stub-pipe waste outlet and a flexible waste removal hose, as in claim 6, wherein there is a means for the attachment of a waste removal hose at the waste discharging end of the pipe means.

12. A waste removal conduit attachment for use with mobile sewage units having an external stub-pipe waste outlet and a flexible waste removal hose, as in claim 11, wherein the attachment means for the waste removal hose is a stub pipe.

13. A waste removal conduit attachment for use with mobile sewage units having an external stub-pipe waste outlet and a flexible waste removal hose, as in claim 7, wherein there is a means for the attachment of a waste removal hose at the waste discharging end of the pipe means.

14. A waste removal conduit attachment for use with mobile sewage units having an external stub-pipe waste outlet and a flexible waste removal hose, as in claim 13, wherein the attachment means for the waste removal hose is a stub pipe.

15. A waste removal conduit attachment for use with mobile sewage units having an external stub-pipe waste outlet and a flexible waste removal hose, as in claim 8, wherein there is a means for the attachment of a waste removal hose at the waste discharging end of the pipe means or any additions or extensions to the waste discharging end of the pipe means.

16. A waste removal conduit attachment for use with mobile sewage units having an external stub-pipe waste outlet and a flexible waste removal hose, as in claim 15, wherein the attachment means for the waste removal hose is a stub pipe.

17. A method of making a waste-removal conduit attachment from standard plumbing parts by
a) obtaining a rigid, water and temperature resistant pipe, said pipe having an angled or elbowed shape and having a female, collared, waste discharging end and a non-collared waste receiving end;
b) obtaining a rigid, water and temperature resistant female hose adaptor having a collared, female end and a non-collared end;
(c) permanently bonding the non-collared waste receiving end of the angled or elbowed pipe to the inside of the collared female end of the female hose adaptor;
(d) obtaining a stub-pipe;
(e) permanently bonding the stub-pipe to the collared waste discharging end of the angled or elbowed pipe;
(f) obtaining a rigid, water and temperature resistant pipe, the waste receiving end of which has a lip, flange or other enhancement of its external diameter, the remaining length having an external diameter that can snugly fit within the non-collared end of the female hose adaptor;
g) obtaining an annular coupler with an internal diameter capable of freely encircling the body of the flanged pipe and having an external diameter that is wider than that of the flanged end, sufficient to permit the engaging means of the annular coupler to properly contact and fully engage the pegs protruding from an outlet stub-pipe; and,
h) inserting a gasket between the points of contact of the annular coupler, flanged pipe, and outlet stub-pipe.

18. The method of 17 further comprising the step of making an annular coupler by obtaining a hooked termination cap and cutting a circular opening in the center of the cap, said circular opening having a diameter capable of freely encircling the body of the flanged pipe and having an external diameter that is wider than that of the flanged end, sufficient to permit the engaging means of the annular coupler to properly contact and fully engage the pegs protruding from an outlet stub-pipe.
